(19) United States
(12) Patent Application Publication
(10) Pub. No.: US 2022/0161632 A1
(43) Pub. Date: May 26, 2022

(54) TRIM ELEMENT COMPRISING A HEATING ELEMENT MADE FROM A CARBON MATERIAL

(71) Applicant: FAURECIA INTERIEUR INDUSTRIE, Nanterre (FR)

(72) Inventors: Godefroy BEAU, LA GARENNE COLOMBES (FR); Xavier TONEU, GANDIA (ES); Lionel HAFER, SAINT-JEAN ROHRBACH (FR)

(21) Appl. No.: 17/531,279

(22) Filed: Nov. 19, 2021

(30) Foreign Application Priority Data
Nov. 20, 2020 (FR) 20 11932

(51) Int. Cl. B60H 1/22; B60R 13/02; G06F 3/044; G06F 3/041; B32B 38/00; B32B 9/00; B32B 9/04; H05B 3/14; H05B 3/26

(52) U.S. Cl. CPC B60H 1/2227; H05B 2203/032; G06F 3/0443; G06F 3/04164; B32B 38/0004; B32B 9/007; B32B 9/045; H05B 3/145; H05B 3/267; G06F 2203/04103; B60R 2013/0287; B32B 2457/00; B32B 2262/06; B32B 2260/021; B32B 2260/046; B32B 2307/202; H05B 2203/017; B60R 13/02

(57) ABSTRACT

A trim element includes at least one support layer having an inner face and an outer face and at least one functional layer made from a carbon material extending over at least part of the inner face or over at least part of the outer face of the support layer. At least part of the functional layer defines at least one heating element formed by a pattern that includes at least one conductive area made from carbon material and at least one nonconductive area formed by a through opening in the functional layer, the conductive area being supplied by a current source electrically connected to the conductive area.

### TECHNICAL FIELD

The present invention relates to a trim element of the type comprising at least one support layer comprising an inner face and an outer face and at least one functional layer made from a carbon material extending over at least part of the inner face or over at least part of the outer face of the support layer.

The invention also relates to a method for producing such a trim element.

The invention for example applies to a trim element forming a door panel, a center console covering or a dashboard covering of a vehicle or the like.

### BACKGROUND

In order to lighten such a trim element and to reduce its environmental impact, it is known to make the support layer of the trim element from a composite material for example comprising natural fibers embedded in a matrix made from a plastic material.

Furthermore, in such a trim element, it is desirable to integrate certain functionalities intended for occupants of the vehicle on the outer surface of the trim element. Thus, the trim element can for example comprise one or several heating surfaces to improve the comfort of the vehicle.

The heating element arranged to heat part of the outer surface, for example formed by a resistive circuit, is integrated into the trim element, for example under a decorative layer so as to be invisible from the passenger compartment of the vehicle. To this end, the circuit is for example bonded to the support layer before the decorative layer is applied on the support layer. Such a method is complicated, in particular if heating elements are provided on different areas of the support layer. Furthermore, if a heating element is incorrectly positioned on the support layer and/or relative to the decorative layer, the quality of the trim element is reduced because the corresponding heated surface does not extend to the desired location, which may be provided with a visual indication to inform a passenger of the presence of the heated surface.

### SUMMARY

One of the aims of the invention is to address these drawbacks by proposing a trim element comprising at least one heated surface that may be made simply and reliably.

To this end, the invention relates to a trim element of the aforementioned type, wherein at least part of said functional layer defines at least one heating element formed by a pattern comprising at least one conductive area made from carbon material and at least one nonconductive area formed by a through opening in the functional layer, said conductive area being supplied by a current source electrically connected to the conductive area.

By making the pattern in a functional layer made from carbon material, the heating element can be positioned precisely on the support layer simply and reliably. Furthermore, when several heating elements or other functional elements are provided, they may all be made in the functional layer(s), which limits the operations to produce the trim element and simplifies the relative positioning of the various functional elements on the support layer.

According to other optional features of the trim element according to the invention, considered alone or according to any technically possible combination:
the heating element formed by the pattern of the functional layer is a resistive circuit arranged to heat at least part of an outer surface of the trim element;
the functional layer extends over the outer face of the support layer;
the conductive area is electrically connected to the current source by an electrical connector extending in the support layer, said electrical connector being in contact with the conductive area on the outer face of the support layer;
the trim element further comprises a proximity sensor arranged to detect the presence of part of a user's body near and/or in contact with an outer surface of the trim element, the supply of the heating element being cut when such presence is detected by the proximity sensor;
the proximity sensor is formed by a capacitive circuit formed in an additional layer made from carbon material, said capacitive circuit being electrically connected to a current source;
the additional layer made from carbon material extends over an inner face of a decorative layer extending opposite the outer face of the support layer and forming the outer surface of the trim element;
the support layer is made from a composite material comprising natural fibers in a polypropylene matrix; and
the functional layer forms a reinforcing layer of the support layer arranged to improve the mechanical characteristics of the trim element.

According to another aspect, the invention relates to a method for producing a trim element as described above, comprising the following steps:
providing a support layer,
applying a layer made from carbon material over at least part of the inner face or at least part of the outer face of the support layer to form a functional layer,
cutting the functional layer over its entire thickness so as to produce a pattern comprising at least one conductive area made from carbon material and at least one nonconductive area formed by a through opening in the functional layer so as to form a heating element,
electrically connecting the conductive area of the pattern of the functional layer to a current source.

According to another feature of the method according to the invention, the layer made from carbon material is cut by laser etching, chemical etching, milling or mechanical piercing in the carbon material.

### BRIEF DESCRIPTION OF THE DRAWINGS

Other aspects and advantages of the invention will appear upon reading the following description, provided as an example, and done in reference to the appended drawings, in which:

FIG. 1 is a schematic sectional illustration of part of a trim element according to one embodiment of the invention,

FIG. 2 is a schematic sectional illustration of part of a functional element according to another embodiment of the invention,

FIGS. 3 to 5 are schematic sectional illustrations of part of a trim element during different steps of a method for producing the trim element,

FIG. 6 is a schematic a lustration of a pattern made in the functional layer to form a resistive heating circuit,

FIG. 7 is a schematic sectional illustration of part of a trim element according to another embodiment of the invention, and

FIG. 8 is a schematic sectional illustration of part of a trim element according to another embodiment of the invention.

### DETAILED DESCRIPTION

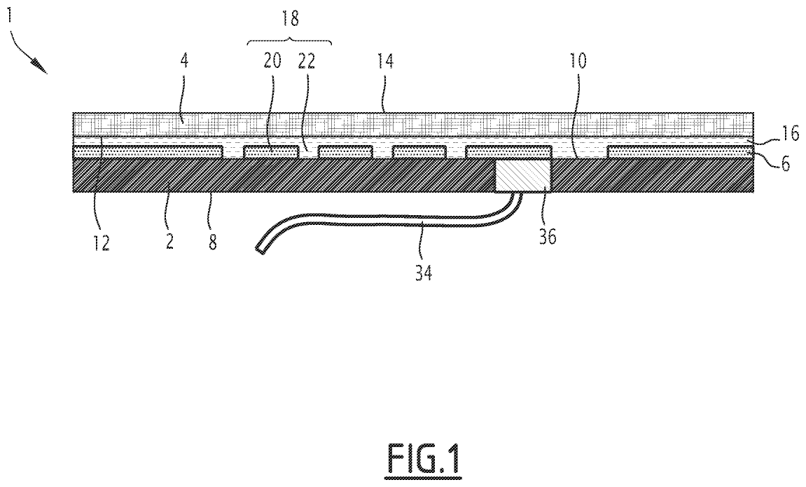

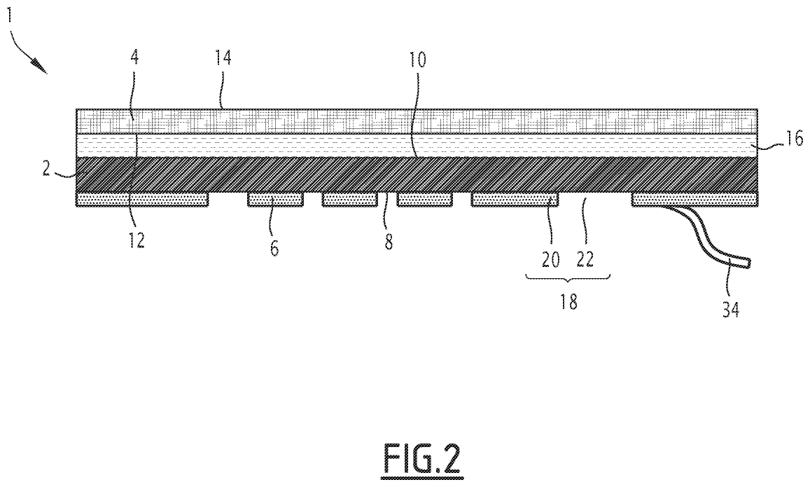

In reference to FIGS. 1 and 2, a vehicle trim element 1 is described comprising at least one support layer 2, one decorative layer 4 and one functional layer 6. Such a trim element is for example intended to form a door panel, a dashboard cover or a center console cover or the like.

The support layer 2 is arranged to impart its shape and its mechanical properties to the trim element 1, in particular its rigidity. The support layer 2 is thus for example made from a substantially rigid material for a door panel, such as a plastic or composite material. According to one embodiment, the support layer 2 is made from a composite material comprising natural fibers in a polypropylene matrix, also known under the name NFPP for “Natural Fiber PolyPropylene.” The natural fibers are for example chosen from linen, hemp, kenaf and/or wood. The support layer 2 is for example formed by thermocompression in a pressing tool having the desired shape of the support layer 2, which corresponds to the shape of the trim element 1. Thus, the support layer 2 for example has a three-dimensional shape with raised areas. As an example, the support layer 2 can for example comprise a raised area relative to the rest of the support layer 2 to form an armrest.

In a variant, the support layer 2 is made by injecting plastic material, such as polypropylene (PP), polycarbonate acrylonitrile butadiene styrene (PC ABS) or the like, into a molding cavity having the desired shape. According to another variant, the support layer 2 is obtained by additive manufacturing in the desired shape.

The support layer 2 comprises an inner face 8, intended to face the side of the part of the vehicle on which the trim element must be installed, such as the door of the vehicle in the case of a door panel, and an outer face 10, opposite the inner face 8, and intended to face toward the passenger compartment of the vehicle.

The decorative layer 4 extends on the side of the outer face 10 of the support layer 2 over at least a part thereof. The decorative layer 4 is arranged to impart its appearance and its feel to the trim element 1. The decorative layer 4 is thus for example made from a flexible or rigid material, having a particular appearance and/or feel that one wishes to impart to the trim element 1. Thus, the decorative layer 4 is for example made from a textile material, a plastic material, a ligneous material, leather or artificial leather or the like. The decorative layer 4 is molded to the outer face 10 of the support layer 2, that is to say, it substantially marries the shape of the outer face 10 in the area of the support layer 2 that it covers. According to one embodiment, the decorative layer 4 covers the entire support layer 2.

The decorative layer 4 comprises an inner face 12 extending opposite the outer face 10 of the support layer 2 and an outer face 14 extending toward the outside of the trim layer 1 and forming the outer surface of the trim element 1, that is to say, forming the visible part of the trim element 1 from the passenger compartment of the vehicle. The outer face 14 can comprise decorative patterns or indications intended for a user to indicate the presence of a functional area to the user, for example, as will be described later. In a variant or additionally, the decorative layer 4 can be translucent, at least in certain areas, to allow light to pass from the inner face 12 to the outer face 14, which makes it possible to backlight these areas in order to inform a user of the presence of a heated area or of another functional area, for example.

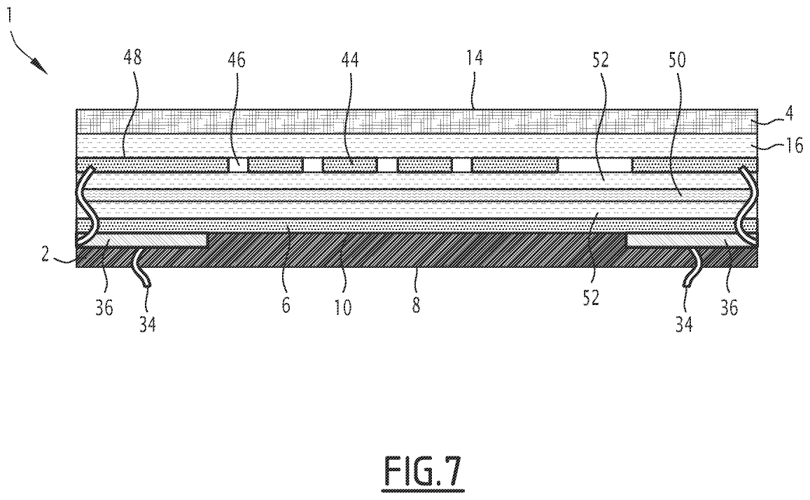

According to one embodiment, the decorative layer 4 is fastened directly on the support layer 2 (FIG. 2), in which case a connecting layer 16, for example of glue, an adhesive, a heat-activatable polypropylene film, extends between the outer face 10 of the support layer 2 and the inner face 12 of the decorative layer 4. In a variant, a functional layer 6, and possibly other additional layers, is (are) interposed between the support layer 2 and the decorative layer 4, in which case a connecting layer 16 extends between the functional layer 6 and the inner face of the decorative layer 4 (FIGS. 1 and 7). It is understood that the decorative layer 4 can be fastened in another suitable way to the support layer 2 or to another layer. Such fastening can for example be obtained by sewing, overmolding, welding or foaming of another connecting layer, in particular based on the materials used to produce the support layer 2 and/or the decorative layer 4.

Alternatively, the trim element 1 has no decorative layer 4 and the outer surface 14 of the trim element is formed by the outer face of the support layer 2 and/or by the functional layer 6 extending over the support layer 2.

The functional layer 6 is a layer made from a carbon material and comprising at least one pattern 18 forming a heating element to heat at least part of the outer surface of the trim element 1, as will be described later. The material for example assumes the form of carbon fibers without sizing and/or of recycled carbon fibers. Not having sizing makes it possible to improve the electrical properties of the pattern 18. The pattern 18 thus has better conductivity and better electrical contact continuity after the three-dimensional shaping of the trim element, as will be described later. The functional layer 6 for example has a thickness substantially between 20 μm and 200 μm. In addition, the carbon material can also comprise polypropylene, for example in a quantity less than or equal to 40% by weight of the composition of the functional layer.

According to one embodiment, the functional layer 6 is arranged to form a reinforcing layer of the support layer 2. Such a reinforcing layer improves the mechanical properties of the trim element, particularly in terms of rigidity and self-support, more particularly when the support layer 2 is made from composite material. According to one embodiment, the functional layer 6 is formed by a film bonded or laminated on the support layer 2 and/or the decorative layer 4. In this case, the functional layer does not necessarily form a reinforcing layer of the support layer 2.

The functional layer 6 extends over at least part of the inner face 8 or over at least part of the outer face 10 of the support layer 2 depending on the function to be performed, as will be described later. In the case of a reinforcing layer, the functional layer 6 is more particularly applied on areas of the support layer 2 needing to be reinforced. According to one embodiment, the functional layer 6 extends over the entire surface of the inner face 8 or of the outer face 10 of the support layer. According to one embodiment, the functional layer 6 is applied directly on the support layer 2, that is to say, there is no intermediate layer between the support layer 2 and the functional layer 6. The functional layer 6 is molded to the part of the face of the support layer 2 that it covers, that is to say, the functional layer 6 marries the shape of this part of the face of the support layer 2.

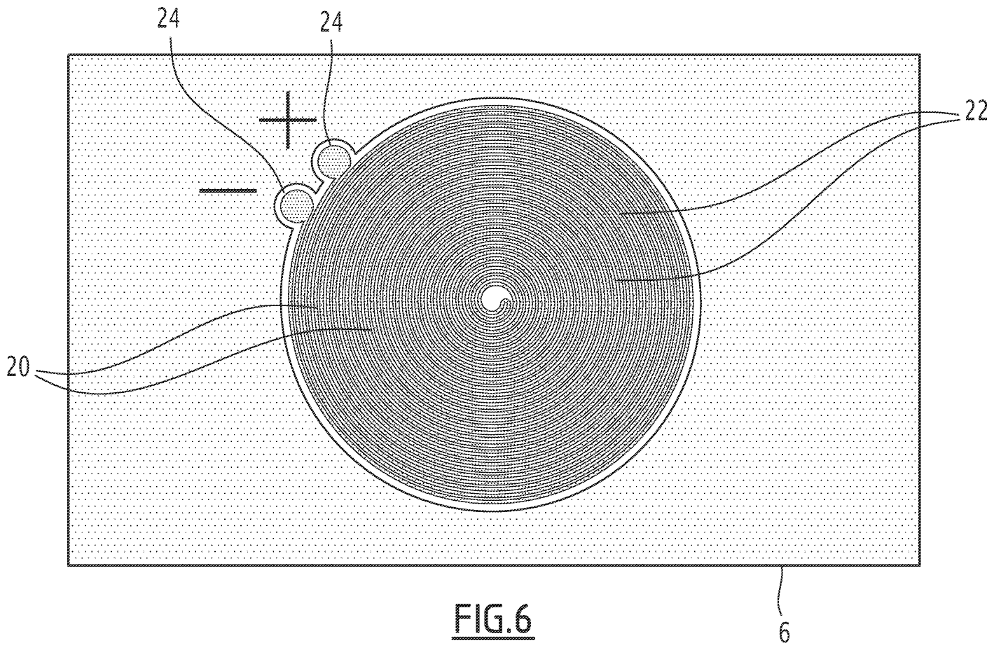

The pattern 18 comprises at least one conductive area 20 formed by the carbon material of the functional layer 6 and at least one nonconductive area 22 formed by a through opening in the thickness of the functional layer 6. The shapes of the conductive area 20 and of the nonconductive area 22, an example of which is shown in FIG. 6, are arranged so that the pattern 18 forms a heating element when the conductive area 20 is supplied with electricity. In other words, the pattern 18 is such that the functional layer 6 defines at least one electrical circuit forming a heating element when the circuit is supplied. Depending on the surface to be heated and its shape, a pattern may comprise several separate conductive areas 20 and nonconductive areas 22. In general, the pattern 18 comprises a nonconductive area 22 surrounding the conductive area(s) 20 in order to isolate the electrical circuit forming the heating element from the rest of the functional layer 6.

To form a heating element, the pattern 18 is arranged to form a resistive circuit, preferably extending over the outer face 10 of the support layer 2 in order to be as close as possible to the outer surface 14 of the trim element, as shown in FIG. 1. In this case, the functional layer 6 extends over the outer face 10 of the support layer 2, for example between the outer face 10 and the decorative layer 4. Such a resistive circuit makes it possible to heat part of the outer surface 14 of the trim element opposite the pattern 18 when the conductive area 20 of the pattern 18 is electrically supplied. The shape of the resistive circuit for example corresponds to the shape of the heated area on the outer surface 14 of the trim element 1. Thus, as shown in FIG. 6, the contour of the pattern 18 is for example circular and comprises several conductive areas 20 having a spiral shape separated by nonconductive areas 22 also having a spiral shape. At the end of the conductive areas 20, two connection terminals 24 are provided for connection to a current source (not shown), as will be described later. This pattern shape is provided solely as an example, and it is understood that other shapes can be provided depending on the shape of the area to be heated on the outer surface 14 of the trim element 1. According to one embodiment, the conductive area of the pattern 18 is formed by a wider zone of the functional layer and the through opening(s) forming the nonconductive area(s) are formed by the contour of this wider zone.

According to the embodiment shown in FIG. 2, the functional layer 6 is applied on the inner face 8 of the support layer 2 and the pattern 18 forming the heating element extends in this functional layer 6 and therefore also extends over the inner face 8 of the support layer 2. In such an embodiment, the outer surface 14 of the trim element 1 is formed by the outer face 10 of the support layer and the heating element remains hidden from the outside of the trim element 1. According to another embodiment, functional layers 6 are provided on the inner face 8 and on the outer face 10 of the support layer 2. In this case, the pattern 18 can be formed in one or both functional layers 6.

According to one embodiment, part of the resistive circuit forming the heating element, and more particularly the part of the circuit that is heated when the heating element is supplied, is formed in the functional layer 6 applied on the outer face 10, and another part of the resistive circuit, more particularly the part of the circuit that comprises the connection terminals 24, is formed in the functional layer 6 that extends over the inner face 8 of the support layer 2. The two parts of the resistive circuit are connected together by one or several connection elements, such as connection rods, extending through the support layer 2. Such a connection element is for example formed by a conductive material filling an orifice extending in the support layer 2 between the parts of the resistive circuit connected together. This embodiment is advantageous to facilitate the connection of the resistive circuit to a current source, as will be described later. According to one embodiment, the part of the circuit that comprises the connection terminals 24 is not formed in a functional layer, but is applied alone on the inner face 8 of the support element 2.

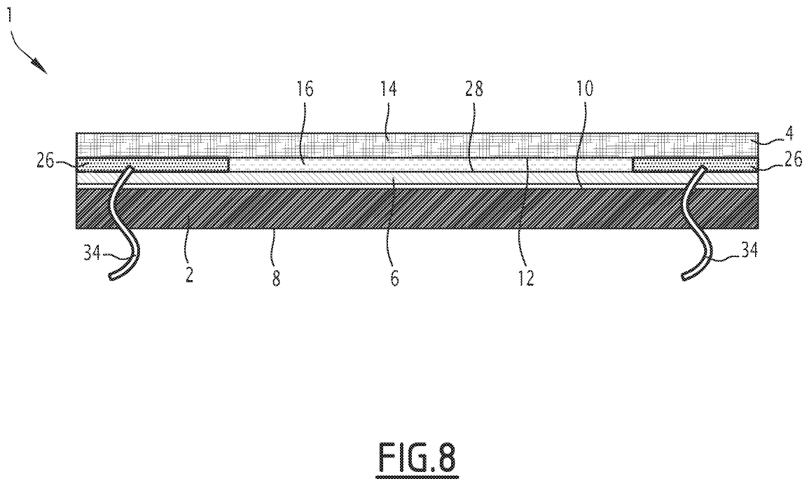

According to another embodiment shown in FIG. 8, the heating element comprises two electrodes 26 applied on the functional layer 6. The electrodes 26 are spaced apart from one another and are applied on different areas of the functional layer 6. The part of the functional layer 6 that extends between the areas on which the electrodes 26 are applied forms a heating part 28, which is heated by Joule effect when an electric current enters this heating part 28 from one electrode 26 to the other electrode 26. As a result, according to this embodiment, only the outer contour of the heating part 28 forming the pattern 18 must be cut to form a nonconductive area, and the method for producing the trim element 1 can be simplified. According to the embodiment of FIG. 8, the functional layer 6 extends over the outer face of the support layer. In a variant, the functional layer 6 extends over the inner face of the support layer 2. According to a variant, the electrodes 26 are inserted into the functional layer 6.

It is understood that other functional elements can be formed in the functional layer(s) 6 of the trim element 1 in addition to the heating element(s). Such functional elements for example comprise one or several capacitive circuits to form a touch-sensitive slab, a touch-sensitive surface called “touch slider” or a touch-sensitive button on the outer surface 14 of the covering element 1, one or several flexible resistive circuits able to be deformed to detect pressure on the outer surface 14 of the trim element to form a pressure sensor. Such functional elements are also formed by patterns formed in the functional layer(s), these patterns being separate from the pattern(s) 18 forming the heating element(s).

The or each pattern 18 is supplied with electricity by at least one current source (not shown) electrically connected to the conductive area(s) 20 of the pattern 18, for example connected to each terminal 24 of the patterns 18. The current source is connected to the conductive area 20 for example by a power cable 34 connected directly (FIG. 2) or by an electrical connector 36 to the conductive area 20 of the pattern 18 (FIG. 1). When the pattern 18 extends over the outer face 10 of the support layer 2, the power cable 34 for example passes through a through opening formed in the support layer 2, the conductive area 20 of the pattern 18 for example extending over or around part of the through opening. When a connector 36 is provided, the latter for example extends in the through opening 38 from the inner face 8 to the outer face 10 of the support layer 2, as shown in FIG. 1. The power cable 34 is then connected to the electrical connector 36 on the side of the inner face 8 of the support layer 2 and the electrical connector 36 is connected to the conductive area 20 on the side of the outer face 10 of the support layer 2. According to one embodiment previously described, the power cable 34 can be connected to the connection terminals 24 extending on the inner face 8 of the support layer 2, the electrical current supplying the heating part of the resistive circuit by the connection elements extending through the support layer 2. The power cable 34 is for example connected to the electrical system of the vehicle, which then forms the current source. When several circuits are provided in the functional layer(s) 6, each circuit is supplied by a same current source or by several current sources by power cables 34.

According to one particular embodiment, the trim element can further comprise a transparent or translucent covering extending over the decorative layer 4 or over the support layer and/or the functional layer 6, through which the decorative layer 4 or the support layer and/or the functional layer 6 is visible. Such a covering is for example a varnish or translucent film, for example with a base of polypropylene making it possible to protect the decorative layer 4 or the support layer 2 and/or the functional layer, and in particular to avoid deterioration of the pattern(s) 18. It is particularly interesting to make the support layer visible in the case where the support layer has a satisfactory appearance, for example in the case of a layer made from NFPP.

In some cases, the functions have been described in reference to a particular positioning of the functional layer on one of the faces of the support layer 2. It is, however, understood that the same functions could be performed by placing the functional layer 6 on the other face of the support layer 2.

The trim element described above makes it possible to incorporate one or several heating elements, and possibly other functional elements, into the functional layer(s) 6 of the support layer 2, thus reducing the complexity of the trim element and allowing easier positioning of these elements with respect to the support layer 2 and/or the decorative layer 4.

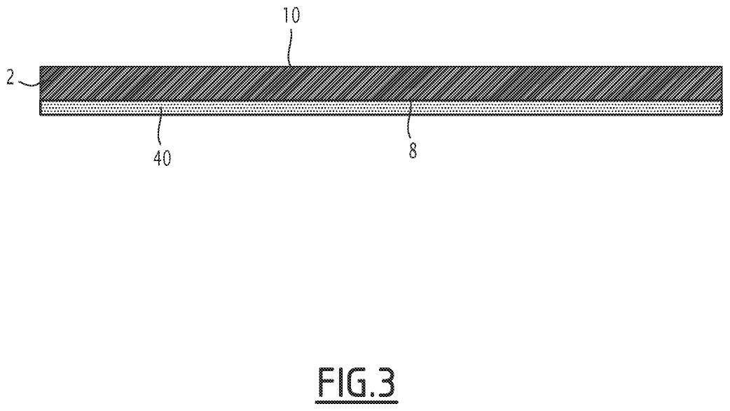

A method for producing a trim element according to an embodiment previously described will now be described in reference to FIGS. 3 to 5.

A support layer 2 is first provided, on which a layer made from carbon material 40 is deposited. The layer of carbon material 40 is deposited over all or part of the inner 8 or outer 10 face of the support layer 2 depending on the desired function, as previously described. According to one embodiment, a layer of carbon material 40 is deposited on the inner face 8 and another is deposited on the outer face 10 of the support layer 2. In FIG. 3, the layer of carbon material 40 extends over the inner face 8 of the support layer 2. The deposition of the layer of carbon material 40 is for example obtained by assembling a web of carbon fibers and polypropylene fibers derived from a needling method and applied on the support layer 2. According to one embodiment, the layer of carbon material 40 also forms a reinforcing layer of the support layer 2.

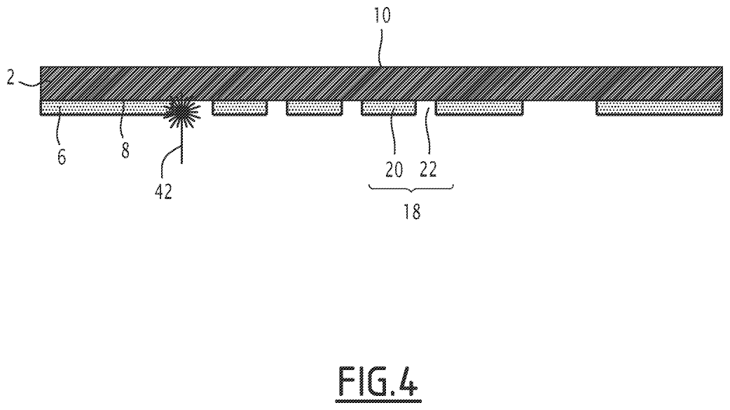

As shown in 4, the pattern 18 is next made in the layer of carbon material 40. To do this, at least one through opening is formed all the way through the layer of carbon material 40 so as to produce the nonconductive area 22. “All the way through” means that the layer of carbon material 40 is cut over its entire thickness. The shape of the through openings(s) in the layer of carbon material 40 defines the shape of the pattern 18 and of the conductive area(s) 20 thereof. According to the embodiment of FIG. 4, the carbon layer 40 is hollowed using laser radiation 42, which allows the shape of the pattern 18 to be defined very precisely. In a variant, the layer of carbon material 40 is cut by chemical etching, milling or mechanical piercing in the carbon material. As previously described, several patterns 18 can be provided in the functional layer 6.

It is understood that the pattern(s) 18 could also be made before application of the layer(s) of carbon material 40 on the support layer 2.

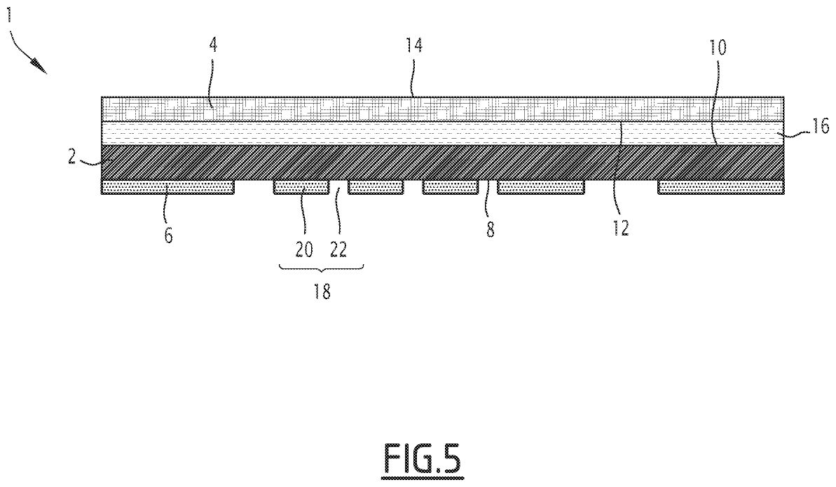

If applicable, the decorative layer 4 is next fastened, for example by bonding, on the support layer 2 and/or on the functional layer 6, as shown in FIG. 5.

If applicable, a transparent or translucent covering is applied on the decorative layer 4 or on the support layer 2 and/or on the functional layer 6.

The conductive area(s) 20 are next connected to one or several current sources, for example during mounting of the trim element 1 on the vehicle. When an electrical connector 36 is provided, the latter is for example introduced into a through opening previously made in the support layer 2. Likewise, when connection elements are provided, they are first introduced into through orifices made beforehand in the support layer 2.

A step of three-dimensional shaping of the support layer 2 can be provided to impart the desired shape to the trim element. This step can be done before or after assembly of the decorative layer 4 and/or application of the covering.

This method is therefore particularly simple and inexpensive to implement.

Furthermore, the positioning of the pattern(s) 18 can be ensured precisely.

According to one particular embodiment shown in FIG. 7, the trim element 1 further comprises a proximity sensor 44 arranged to detect the presence of part of a user's body near and/or in contact with a heated area of the outer surface 14 of the trim element. The proximity sensor 44 is thus arranged to detect whether a user, for example with his hand or his fingers, approaches the outer surface 14 of the trim element, more particularly an area heated by a heating element. The proximity sensor is further arranged to turn off the heating element when a part of a user's body approaches the heated area in order to protect the user from any injury due to the heat from the heated area. More particularly, the proximity sensor is for example arranged to detect the presence of a part of a user's body in a predetermined detection field around the heated area, this predetermined field corresponding to the distance at which the heat could injure the user if this user were to touch the outer surface 14 of the trim element in this area. In other words, the heating element is turned off when the proximity sensor detects the presence of a part of a user's body too close to the area of the outer surface 14 heated by the heating element.

According to the embodiment shown in FIG. 7, the proximity sensor 44 is formed by a pattern 46 formed in an additional layer made from carbon material 48. More particularly, the pattern 46 is cut in the additional layer of carbon material 48 in order to form a capacitive circuit emitting a detection field around the heated area on the side of the outer surface 14 of the trim element 1 when the capacitive circuit is supplied. The pattern 46 is also formed by defining nonconductive areas in the additional layer 48, these nonconductive areas being formed by through openings in the additional layer 48. To power the capacitive circuit, the capacitive circuit is electrically connected to a current source, for example the same current source as that which supplies the heating element. To this end, the conductive area(s) of the capacitive circuit are for example connected to one or several electrical connectors 36 in the support layer by one or several power cables 34, as shown in FIG. 7. To emit a detection field on the side of the outer surface 14 of the trim element, the additional layer 48 extends near the outer surface, for example near the decorative layer 4, for example against an inner face thereof or against the connecting layer 16 by which the decorative layer 4 is fastened to the support layer 2 and/or to the functional layer 6.

According to the embodiment of FIG. 7, a barrier layer 50 extends between the functional layer 6 and the additional layer 48. The barrier layer 50 is arranged to promote the emission of the detection field toward the outside of the trim element 1 rather than toward the support layer 2. The barrier layer 50 is for example resistant to high temperatures so as to prevent it from being damaged when the heating element heats the outer surface 14 of the trim element 1. The barrier layer 50 can be arranged between two layers of adhesive 52 in order to allow adhesion of the barrier layer 50 on the functional layer 6 and/or on the support layer 2 and to allow the adhesion of the additional layer 48 to the barrier layer 50.

The additional layer of carbon material is for example cut to form the pattern 46, as previously described in reference to the pattern 18 forming the heating element and the additional layer of carbon material is laminated with the barrier layer 50. This assembly is next fastened on the functional layer 6 comprising the pattern 18 and/or on the support layer 2 and, if applicable, the decorative layer 4 is next fastened on the additional layer 48. The connection to the current source(s) is next done, as previously described.

1. A vehicle trim element comprising at least one support layer comprising an inner face and an outer face and at least one functional layer made from a carbon material extending over at least part of the inner face or over at least part of the outer face of the support layer, wherein that at least part of said functional layer defines at least one heating element formed by a pattern comprising at least one conductive area made from carbon material and at least one nonconductive area formed by a through opening in the functional layer, said conductive area being supplied by a current source electrically connected to the conductive area.

2. The trim element according to claim 1, wherein the heating element formed by the pattern of the functional layer is a resistive circuit arranged to heat at least part of an outer surface of the trim element.

3. The trim element according to claim 1, wherein the functional layer extends over the outer face of the support layer.

4. The trim element according to claim 3, wherein the conductive area is electrically connected to the current source by an electrical connector extending in the support layer, said electrical connector being in contact with the conductive area on the outer face of the support layer.

5. The trim element according to claim 1, further comprising a proximity sensor arranged to detect the presence of part of a user's body near and/or in contact with an outer surface of the trim element, the supply of the heating element being cut when such presence is detected by the proximity sensor.

6. The trim element according to claim 5, wherein the proximity sensor is formed by a capacitive circuit formed in an additional layer made from carbon material, said capacitive circuit being electrically connected to a current source.

7. The trim element according to claim 6, wherein the additional layer made from carbon material extends over an inner face of a decorative layer extending opposite the outer face of the support layer and forming the outer surface of the trim element.

8. The trim element according to claim 1, wherein the support layer is made from a composite material comprising natural fibers in a polypropylene matrix.

9. The trim element according to claim 1, wherein the functional layer forms a reinforcing layer of the support layer arranged to improve the mechanical characteristics of the trim element.

10. A method for manufacturing a trim element according to claim 1, comprising the following steps:
providing a support layer,
applying a layer made from carbon material over at least part of the inner face or at least part of the outer face of the support layer to form a functional layer,
cutting the functional layer over its entire thickness so as to produce a pattern comprising at least one conductive area made from carbon material and at least one nonconductive area formed by a through opening in the functional layer so as to form a heating element,
electrically connecting the conductive area of the pattern of the functional layer to a current source.

11. The manufacturing method according to claim 10, wherein the layer made from carbon material is cut by laser etching, chemical etching, milling or mechanical piercing in the carbon material.
